(19) United States
(12) Patent Application Publication
(10) Pub. No.: US 2007/0082660 A1
(43) Pub. Date: Apr. 12, 2007

(54) Method and system for network-aware applications

(76) Inventors: Brian K. Smith, Wellington, FL (US); Srinath Subramanian, Davie, FL (US); Jorge L. Perdomo, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/247,413

(22) Filed: Oct. 11, 2005

(51) Int. Cl. H04M 3/00

(52) U.S. Cl. 455/418

(57) ABSTRACT

The invention concerns a method (300) and communication device (100) for network-aware applications. The method can include the steps of—in the communications device—switching (314) to a communications network (110, 120, 130), determining (316) an identity of the communications network and in response to determining the identity of the communications network, altering (320) one or more applications (200) in the communications device such that the altered applications correspond to the communications network.

### BACKGROUND OF THE INVENTION

1. Field of the Invention

This invention relates in general to the management of applications in a communications device, and more particularly, to the management of user applications in the communications device based on different networks.

2. Description of the Related Art

The use of portable electronic devices has risen in recent years. Cellular telephones and other communication devices, in particular, have become very popular with the public. Recently, manufacturers and wireless carriers have focused on developing communications devices that are able to operate on various communications networks. For example, some dual mode handsets allow users to operate their handsets on a wide area network (WAN) or a wireless local area network (WLAN), depending on the availability of coverage. In current handsets or other dual mode devices, however, no attempt is made to tailor the user's experience when switching from one network to another.

### SUMMARY OF THE INVENTION

The present invention concerns a method for network-aware applications. The method can include the steps of—in a communications device—switching to a communications network, determining an identity of the communications network and in response to determining the identity of the communications network, altering one or more applications in the communications device. The altered applications can correspond to the communications network. As an example, altering the applications can include automatically altering the applications, and the applications may be user engageable applications. As another example, the user engageable applications can include a contact list, a browser, a recent call list, a menu or an e-mail client. The applications may also be non-user engageable applications, like network connection-based settings, which can include firewall settings or data rate settings.

In one arrangement, switching to a communications network can further include switching from a first communications network to a second communications network. As an example, the first and second communications networks can be selected from a global system for mobile (GSM) communications network, a code division multiple access (CDMA) communications network, a universal mobile telecommunications service (UTMS) communications network or a wireless local area network (WLAN) communications network. In another arrangement, the first or second communications networks can include network subtypes. As such, altering one or more applications can further include altering one or more applications in the communications device such that the altered applications can correspond to the network subtype of the second communications network. The method can further include the step of receiving a unique identifier to identify the network subtype.

The present invention also concerns a communication device for network-aware applications. The device can include a network access module that is capable of receiving communications signals from at least two communications networks and switching in one of the communications networks and a network-aware processor. The network aware processor can be programmed to determine the identity of the communications network that the network access module switches in for operation with the communication device and in response, to alter one or more applications in the communication device. The altered applications can correspond to the communications network that is switched in for operation of the communication device.

The communication device can further include a network profiles module that can store application profiles for one or more of the communications networks from which the network access module is capable of receiving communications signals. In addition, the network-aware processor can be further programmed to access from the network profiles module the application profile that corresponds to the communications network that has been identified to enable the network-aware processor to alter the applications. The communication device can also include suitable software and circuitry to enable it to perform any of the above-described processes.

The present invention also concerns a machine readable storage having stored thereon a computer program having a plurality of code sections executable by a communication device. The computer program can cause the communication device to perform the steps of switching to a communications network, determining an identity of the communications network and in response to determining the identity of the communications network, altering one or more applications in the communications device such that the altered applications can correspond to the communications network. The computer program can also cause the communications device to perform any of the above-described processes.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a communication device and a plurality of communications networks in accordance with an embodiment of the inventive arrangements;

FIG. 2 illustrates a block diagram of the communication device of FIG. 1 in accordance with an embodiment of the inventive arrangements; and

FIG. 3 illustrates a method for network-aware applications in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “module” can be defined as any combination of hardware and/or software to enable an appropriate function to be performed.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns a method and a communication device for network-aware applications. In one arrangement, the method can include the steps of—in the communications device—switching to a communications network, determining an identity of the communications network and in response to determining the identity of the communications network, altering one or more applications in the communications device. The applications can be altered such that the altered applications correspond to the communications network. As an example, the applications can be user engageable applications, such as a contact list, a browser favorite uniform resource locator list, a recent call list, a main menu, or an e-mail client. As another example, the applications can be non-user engageable applications, like network connection-based settings, such as firewall settings or data rate settings. The invention can help the communications device, particularly from a user's perspective, seamlessly shift between communications networks.

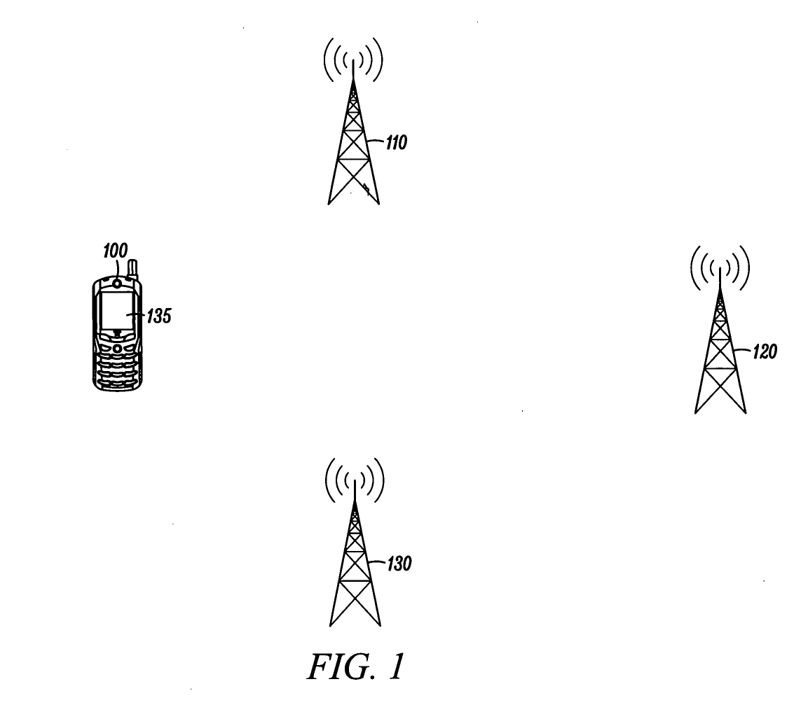

Referring to FIG. 1, a communication device 100 that can communicate with one or more communications networks 110, 120, 130 is shown. As an example, the communication device 100 can be a multimode communication device that can switch between the communications networks 110, 120, 130 in accordance with predetermined settings or criteria, as is known in the art. In one arrangement, the communication device 100 can be a portable handset, although the communication device 100 may also be a laptop computer or any other device capable of communicating with one or more networks. The communication device 100 may also be capable of communicating with other portable communications devices without the assistance of a communications network. The device 100 may include an illumination device 135, such as a display, one or more light-emitting diodes (LEDs) or a light pipe, and can illuminate in one or more different colors. The intensity of the colored light from the illumination device 135 can also be varied.

As an example, the communications networks 110, 120 and 130 can represent a wide range of networks, including but not limited to the following standards: GSM, CDMA and UTMS. In addition, one or more of the communications networks 110, 120 or 130 may be a WLAN or even a short range network, such as a near field communications (NFC) network.

Moreover, one or more of the networks 110, 120 or 130 may include network subtypes. For example, one of the networks 110, 120 or 130 may be a WLAN, and the WLAN may represent numerous WLANs, such as a WLAN at the workplace or home of the user of the device 100 or a WLAN at a retail establishment or public gathering place, like an airport. Also, the networks 110, 120 and 130 may be operated by various carriers, which may also be considered as network subtypes. For example, the network 110 may be a GSM network, and the network subtypes can refer to the different carriers that may operate a GSM network for the device 100. These network subtypes may prompt certain settings or applications to be altered in the device 100. Of course, the invention is not limited to these examples, as the communication device 100 can be designed to switch between any suitable number and type of communications networks.

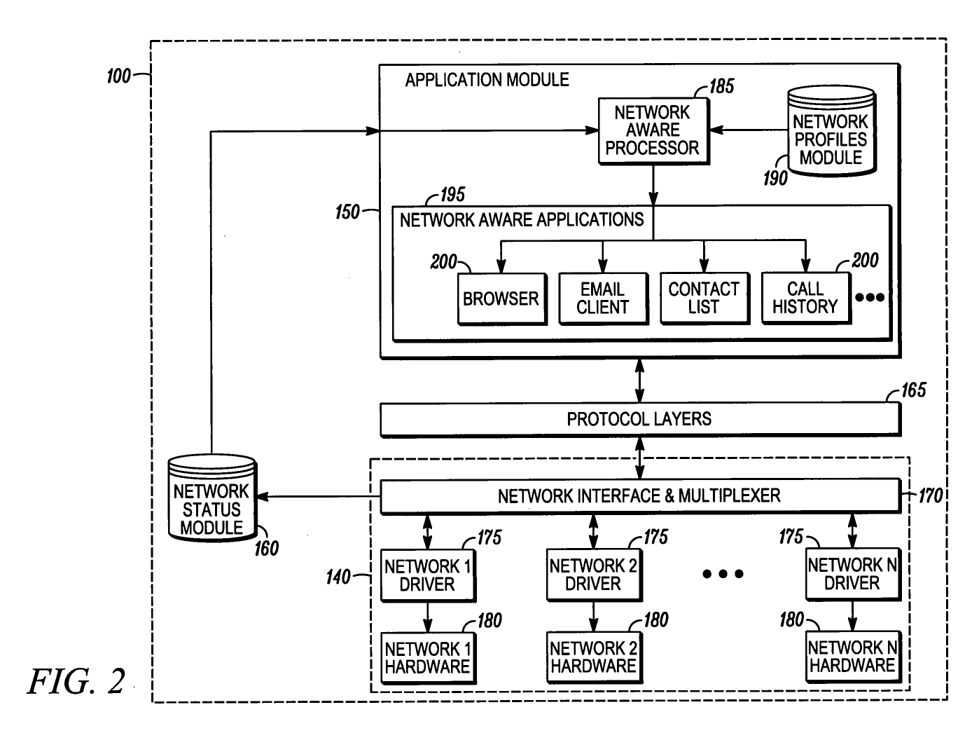

Referring to FIG. 2, a portion of the communication device 100 is shown. Here, the device 100 can include a network access module 140, an application module 150 and a network status module 160, which can signal the application module 150 with relevant network information from the network access module 150, as will be explained later. Briefly, the network access module 140 can control the connections to the various communications networks 110, 120 and 130 (see FIG. 1). Also, the application module 150 can cause certain applications in the device 100 to be altered in view of which communication network 110, 120 130 the device 100 is operating on. Suitable protocol layers 165 can exist in the device 100 to facilitate the transfer of data between the network access module 140 and the application module 150, as is known in the art.

In one arrangement, the network access module 140 can include a network interface and multiplexer 170, which can be coupled to one or more network drivers 175. The network drivers 175 may also be coupled to one or more corresponding network hardware components 180. The network drivers 175 and the network hardware components 180 can include the software and circuitry necessary to allow the communication device 100 to communicate with the communications networks 110, 120 and 130. As such, each of the network drivers 175 and the network hardware components 180 can be unique. In addition, the device 100 can include any suitable number of these units. The network interface and multiplexer 170 can be programmed or set to switch between one or more of the network drivers 175, which can determine the communication network 110, 120 or 130 with which the device 100 will communicate. This process of selecting one of the networks 110, 120 or 130 may be based on predetermined criteria, such as data transmission capabilities, cost and signal strength and is known in the art.

In another arrangement, the application module 150 can include a network-aware processor 185, a network profiles module 190 and one or more network-aware application sets 195. The network-aware processor 185 can be coupled to both the network profiles module 190 and the network-aware application set 195, and the network-aware processor 185 may be a single discrete unit or a combination of units working together to perform the functions described here. In accordance with an embodiment of the invention, the network profiles module 190 can store application profiles for one or more of the communications networks 110, 120, 130. The network-aware processor 185 can access from the network profiles module 190 the application profile that corresponds to the communications network 110, 120, 130 that has been identified as currently serving the communication device 100.

The network-aware application set 195 can include one or more applications 200 that are associated with the communication device 100. As will be explained below, the network-aware processor 185 can alter one or more of the applications 200 such that the altered applications 200 can correspond to one or more of the communications networks 110, 120 or 130.

As an example, one or more of the applications 200 can be user engageable applications. A user engageable application can be any application that a user of the communication device 100 can access and manipulate or control. Suitable examples include a contact list, a browser (such as a Web browser), a recent call list, a menu or an e-mail client. As another example, one or more of the applications 200 can be non-user engageable applications, like network connection-based settings. Suitable examples of network connection-based settings can include firewall settings or data rate settings. A non-user engageable application can be an application that would not be typically accessed and manipulated or adjusted by a user during conventional operation of the device 100. It is understood, however, that the invention is not so limited, as the device 100 can include any suitable number and type of application that may or may not be altered.

In another arrangement, the network status module 160 can signal the illumination device 135 of the device 100 based on which communication network 110, 120 or 130 is serving the device 100. When signaled, the illumination device 135 can display in any suitable fashion one or more colors that can indicate To a user which network 110, 120 or 130 is currently serving the device 100. Different colors can be assigned to different networks to enable the user to distinguish between them. Of course, the user can be made aware of the serving network through any other suitable means.

Also, the intensity of the light being given off by the illumination device 135 can be modified based on the signal strength of the network 110, 120, 130 with which the device 100 is currently communicating. For example, a higher signal strength can result in a particular color being displayed more intensely. Also, the illumination device 135 can display different colors to indicate that a handover is occurring or is about to occur.

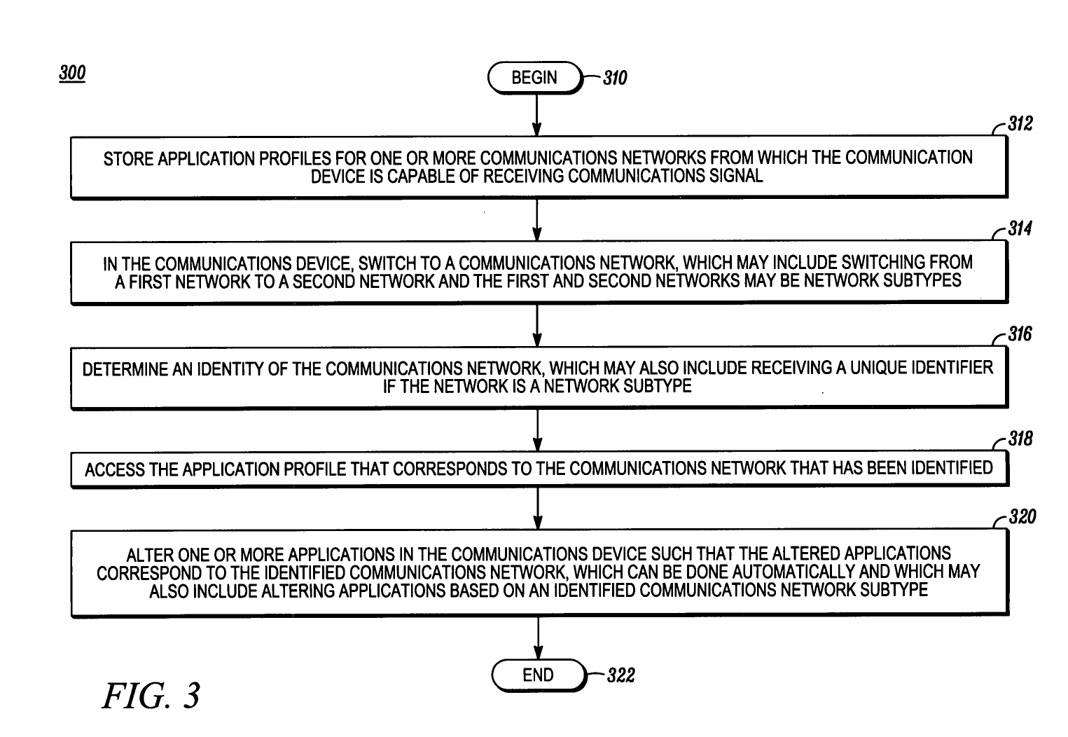

Referring to FIG. 3, a method 300 for network-aware applications is shown. When describing the method 300, reference will be made to FIGS. 1 and 2, although it must be noted that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, the method 300 can begin. At step 312, one or more application profiles for one or more communications networks from which a communications device can receive communications signals can be stored. In addition, at step 314, the communication device can be switched to a communications network, such as from a first communications network to a second communications network. This step may also be applicable if the first or second communications network is a network subtype. An identity of the communications network to which the communication device has been switched can be determined, as shown at step 316. If the communication network is a network subtype, a unique identifier may also be received in step 316.

At step 318, an application profile that corresponds to the communication network that has been identified can be accessed. One or more applications in the communication device can then be altered such that the altered applications can correspond to the identified communications network, as shown at step 320. This altering process can be performed automatically and can also apply to a communications network subtype. At step 322, the method 300 can end.

For example, referring to FIGS. 1 and 2, application profiles can be loaded into the network profiles module 190. These application profiles can be associated with one or more of the communications networks 110, 120, 130 from which the communication device 100 is capable of receiving communications signals. The application profiles can include the information necessary for the network-aware processor 185 to alter the applications 200, as will be described below.

The communications device 100 can also be switched to a communications network 110, 120 or 130. For example, the network interface and multiplexer 170 can determine which communications network 110, 120 or 130 is most appropriate for serving the device 100, in accordance with well-known principles. The network driver 175 and the network hardware component 180 for the selected communications network 110, 120 or 130 can be switched in. This switching process can refer to when the device 100 first powers up and selects a network or when the device 100 switches from a first network to a second network. As a specific example, the device 100 may be currently communicating with a GSM network, and the user may walk into his or her workplace or some other building that is within the coverage of a WLAN. The device 100 may be configured to switch from the GSM network to the WLAN.

As noted earlier, some of the communications networks 110, 120 or 130 may be network subtypes. This switching process may also apply to these types of networks. For example, the communication device 100 may switch from a GSM network provided by a first wireless carrier to another GSM network provided by a second wireless carrier. As another example, the device 100 may switch from a WLAN in a work area to a WLAN in a retail establishment, such as a coffee shop. Those of skill in the art will appreciate that the invention is not limited to these particular examples, as there are numerous scenarios of switching between networks that may apply here.

When the communication device 100 switches to a communications network 110, 120 or 130, the network-aware processor 185 can determine which network 110, 120 or 130 is now serving the device. In particular, the network interface and multiplexer 170 can signal the network status module 160 with the identity of the serving communications network 110, 120 or 130. In turn, the network status module 160 can signal the network-aware processor 185.

As an example, if the serving network is a network subtype, the network interface and multiplexer 170 can also receive a unique identifier to help identify the network. For example, as is known in the art, WLANs may transmit to receiving devices a service set identifier (SSID) that is unique to each particular WLAN. The network interface multiplexer 170 can receive the SSID and can transfer it to the network status module 160, which can send it to the network-aware processor 185. The network-aware processor 185 can then distinguish the WLAN currently serving the device 100 from other WLANs that may have application profiles stored in the network profiles module 190. As such, different application profiles can be stored for WLANs associated with numerous locations, like the user's home or office, an airport or a coffee shop.

Once the communications network 110, 120 or 130 has been identified, the network-aware processor 185 can access from the network profile module 190 the application profile associated with the identified network 110, 120 or 130. This process may also apply to network subtypes.

The network-aware processor 185 can then alter one or more applications 200 in the network-aware application set 195 such that the altered applications 200 correspond to the identified network 110, 120 or 130. For purposes of the invention, the term “alter” can mean the modification or adjustment of any application to enable the application to correspond in some way to the network serving the communication device. This term can also include the launching or termination of an application.

The applications 200 can be user-engageable applications or even non-user-engageable applications. As an example, if the device 100 switches from a GSM network to a WLAN and the WLAN has been identified, the network-aware processor 185 can alter the applications 200 to correspond to the WLAN. As a more specific example, the network-aware processor 185 can alter a recent call list to reflect the most recent calls dialed or received on the WLAN or can modify one or menus to provide the user with access to certain functions that can be performed in the WLAN. Additionally, the processor 185 may adjust settings in an e-mail application or a Web browser to correspond to the WLAN environment. For example, the Web browser may be modified to show a favorite uniform resource locator (URL) list that is associated with the user's past history in the WLAN. As another example, an e-mail contact list can be altered to reflect the user's contacts in the WLAN setting.

In another arrangement and as noted earlier, connection settings, which may or may not be user-engageable, can be modified, too. For example, firewall settings may be adjusted to be more restrictive because the WLAN may be a network used by the device 100 at the user's office. Additionally, connection settings may be modified to take advantage of the higher connection rates associated with the WLAN.

The altering process may be performed for network subtypes, as well. For example, the device 100 may switch from a WLAN at work to a WLAN at a coffee shop. As such, the contact list may be altered to reflect more personal contacts and less business contacts, because the user has left a work setting. As another example, the menus and Web browser of the device 100 may also change, in addition to any relevant connection settings. Although this process has been described as being performed automatically by the device 100, it is also possible for the user to be notified of the switch to a new network, and the user can alter some of the applications 200 manually. It must be stressed, however, that the invention is not limited to any of the examples recited above, as the invention contemplates the altering of any suitable application of the communication device 200. In addition, the invention contemplates the simultaneous altering of applications based on more than one network. That is, the device 100 may be able to operate simultaneously on two or more networks 110, 120 or 130.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for network-aware applications, comprising:
in a communications device, switching to a communications network;
determining an identity of the communications network; and
in response to determining the identity of the communications network, altering one or more applications in the communications device such that the altered applications correspond to the communications network.

2. The method according to claim 1, wherein altering the applications comprises automatically altering the applications.

3. The method according to claim 1, wherein the applications are user engageable applications.

4. The method according to claim 3, wherein the user engageable applications include a contact list, a browser, a recent call list, a menu or an e-mail client.

5. The method according to claim 1, wherein the applications are non-user engageable applications.

6. The method according to claim 5, wherein the non-user engageable applications are network connection-based settings that include firewall settings or data rate settings.

7. The method according to claim 1, wherein switching to a communications network further comprises switching from a first communications network to a second communications network.

8. The method according to claim 7, wherein the first and second communications networks are selected from a global system for mobile (GSM) communications network, a code division multiple access (CDMA) communications network, a universal mobile telecommunications service (UTMS) communications network or a wireless local area network (WLAN) communications network.

9. The method according to claim 7, wherein the first or second communications networks include network subtypes and altering one or more applications further comprises altering one or more applications in the communications device such that the altered applications correspond to the network subtype of the second communications network.

10. The method according to claim 9, further comprising receiving a unique identifier to identify the network subtype.

11. A communication device for network-aware applications, comprising:
a network access module that is capable of receiving communications signals from at least two communications networks and switching in one of the communications networks; and
a network-aware processor that is programmed to:
determine the identity of the communications network that the network access module switches in for operation with the communication device; and
in response, alter one or more applications in the communication device such that the altered applications correspond to the communications network that is switched in for operation of the communication device.

12. The communication device according to claim 11, wherein the processor is further programmed to automatically alter the applications in the communication device.

13. The communication device according to claim 11, further comprising a network profiles module that stores application profiles for one or more of the communications networks from which the network access module is capable of receiving communications signals, wherein the network-aware processor is further programmed to access from the network profiles module the application profile that corresponds to the communications network that has been identified to enable the network-aware processor to alter the applications.

14. The communication device according to claim 11, wherein the applications are user engageable applications.

15. The communication device according to claim 14, wherein the user engageable applications include a contact list, a browser, a recent call list, a menu or an e-mail client.

16. The communication device according to claim 11, wherein the applications are non-user engageable applications.

17. The communication device according to claim 16, wherein the non-user engageable applications are network connection-based settings that include firewall settings or data rate settings.

18. The communication device according to claim 11, wherein the network access module switches from a first communications network to a second communications network and the network-aware processor, in response, alters the applications in the communication device such that the altered applications correspond to the second communications network.

19. The communication device according to claim 18, wherein the first and second communications networks are selected from a global system for mobile (GSM) communications network, a code division multiple access (CDMA) communications network, a universal mobile telecommunications service (UTMS) communications network or a wireless local area network (WLAN) communications network.

20. The communication device according to claim 18, wherein the first or second communications networks include network subtypes and the network-aware processor is further programmed to alter one or more applications in the communication device such that the altered applications correspond to the network subtype of the second communications network.

21. The communication device according to claim 20, wherein the network access module receives a unique identifier and uses the unique identifier to identify the network subtype.

22. The communication device according to claim 11, further comprising a illumination device that displays one or more colors that indicate to a user the communications network that is switched in for operation of the communication device.

23. A machine readable storage, having stored thereon a computer program having a plurality of code sections executable by a communication device for causing the communication device to perform the steps of:
switching to a communications network;
determining an identity of the communications network; and
in response to determining the identity of the communications network, altering one or more applications in the communications device such that the altered applications correspond to the communications network.

24. The machine readable storage according to claim 23, wherein the computer program further causes the communication device to perform the step of switching from a first communications network to a second communications network.
